(19) United States
(12) Patent Application Publication
(10) Pub. No.: US 2015/0114520 A1
(43) Pub. Date: Apr. 30, 2015

(54) HIGH LIMB TREE TRIMMER AND METHOD OF USE

(71) Applicant: CIRCUIT TECHNOLOGY CORPORATION, Northbrook, IL (US)

(72) Inventor: Terrell John Given, Northbrook, IL (US)

(21) Appl. No.: 14/514,030

(22) Filed: Oct. 14, 2014

Related U.S. Application Data
(60) Provisional application No. 61/897,166, filed on Oct. 29, 2013.

(51) Int. Cl. A01G 23/095

(52) U.S. Cl. CPC A01G 23/095
USPC 144/343; 144/24.13

(57) ABSTRACT

A portable and remotely controlled motor and chain/bar apparatus that can trim limbs in excess of about 60 feet from the ground level in an extremely safe manner. An operator on the ground can remove a limb from a safe distance exceeding about 50 feet from where the limb would fall or be lowered to the ground. A motorized chain/bar assembly is secured to a small platform which can easily be lifted for tree delimbing. For safety and stability, the chain/bar cutting platform is secured to all sides of the limb to be cut. Once in position, the operator by applying power to the unit, starts the cycle as the motor chain/bar carriage travels to the top of the platform, the motor/chain/bar rotates from a vertical to a horizontal position and as the motor chain/bar is engaged it travels in a downward motion towards the lower section of the platform creating the pressure required to complete the delimbing process. The bar/chain delimbs at a horizontal position therefore eliminating the common pinching or binding of the bar/chain by the branch during the cutting process.

### CROSS-REFERENCE TO RELATED APPLICATION

The present application claims priority to U.S. Provisional Application Ser. No. 61/897,166, filed Oct. 29, 2013, herein incorporated by reference in its entirety.

### BACKGROUND

The present invention generally relates to tree trimmers. More specifically, the present invention relates to a portable apparatus for remote removal of tree limbs.

Prior to the invention, tree branches could only be removed by an operator climbing the tree, on a ladder at unsafe heights, a manual chain cutter, or by using a truck equipped with a boom with an operator in a bucket with a saw.

High branch delimbing could only previously be accomplished by an operator with a large truck equipped with an extendible boom, an arborist climbing the tree to an unsafe height or an operator using a ladder and chainsaw. Pole saws used to trim branches usually require the operator to stand nearly under where the cut branch would fall and are limited to a height of approximately 12 feet from ground level. This type of saw blade cutter typically gets pinched by the branch due to the angle at which the operator can cut the limb. Delimbing from a large truck with a boom is also limited due to the access area required to position and operate the boom.

Tree trimming is one of the most dangerous occupations. It is estimated that there are over 40,000 trimming related injuries and an average of 80 deaths per year.

Tree trimming trucks, due to their size, cannot always access an area where the trimming needs to be performed. The typical cost of a truck with a boom and bucket is $60,000. It is estimated that today it costs over $100,000 to hire, equip, train, and insure a three-man crew. Branch removal typically costs between two hundred and three hundred dollars per hour.

The present invention seeks to overcome the shortcomings of the prior art, and provide a safe and cost effective means of removing tree branches.

### SUMMARY OF THE INVENTION

Provided herein are apparatuses, systems, and methods of operation for a high limb tree trimmer.

The apparatus for removing tree limbs may generally comprise: a mounting platform; at least one lifting member for lifting the mounting platform to a tree limb; at least one securing assembly for securing the mounting platform to the tree limb; a carriage assembly operably coupled to the mounting platform; a cutting assembly operably coupled to the carriage assembly; and a power source.

A method of removing tree limbs with the inventive apparatus may comprise the steps of: lifting the apparatus to a tree limb with the lifting member; securing the apparatus to the tree limb with the securing assembly; and operating the apparatus.

The present invention relates to an operator guided working tool specifically designed to offer the safest and most cost effective means of trimming tree limbs at virtually any height with a device consisting of a main platform, motor, bar and chain assembly. The cutting tool is manually lifted and secured to the limb to be cut and from virtually any safe operator distance which could be in excess of 50 feet from where the limb would fall or be lowered to the ground. A switch lockout and trigger switch is used to apply power to the unit to maximize operator safety. As power is applied to the unit, the cutting unit travels to the top of the main mounting platform, rotates 90 degrees and the cutting cycle begins and the limb is cut. This tool will delimb branches that could only previously be cut by an operator in a boom/bucket or an operator climbing to possibly unsafe height up to 60 feet. The height and means at which this unit can operate provides the safest tree delimbing possible at any height. The bar/chain delimbs at a horizontal position therefore eliminating the common pinching or binding of the bar/chain by the branch during the cutting process.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is an illustration of one embodiment of the present invention, in a rest position.

FIG. 2 is an illustration of the embodiment of FIG. 1, in an operating position.

FIG. 3 is a back view of FIG. 2.

FIGS. 4-9 are depictions of various views of embodiments of the present invention.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Generally speaking, the present invention comprises an apparatus for remote removal of tree limbs. The apparatus generally comprises a mounting platform, at least one lifting member for lifting the mounting platform to a tree limb, at least one securing assembly for securing the mounting platform to the tree limb, a carriage assembly operably coupled to the mounting platform, and a cutting assembly operably coupled to the carriage assembly. The invention improves the safety of removing high tree limbs. An operator on the ground can remove a limb from a safe distance exceeding 50 feet from where the limb would fall or be lowered to the ground.

A motorized chain/bar assembly is secured to a small platform which can easily be lifted for tree delimbing. For safety and stability, the chain/bar cutting platform is secured to all sides of the limb to be cut. Once in position, the operator may apply power to the unit and start the cycle. As the motor chain/bar carriage travels to the top of the platform, the motor/chain/bar rotates from a vertical to a horizontal position, and as the motor/chain/bar is engaged it travels in a downward motion towards the lower section of the platform creating the pressure required to complete the delimbing process. The bar/chain delimbs at a horizontal position therefore eliminating the common pinching or binding of the bar/chain by the branch during the cutting process.

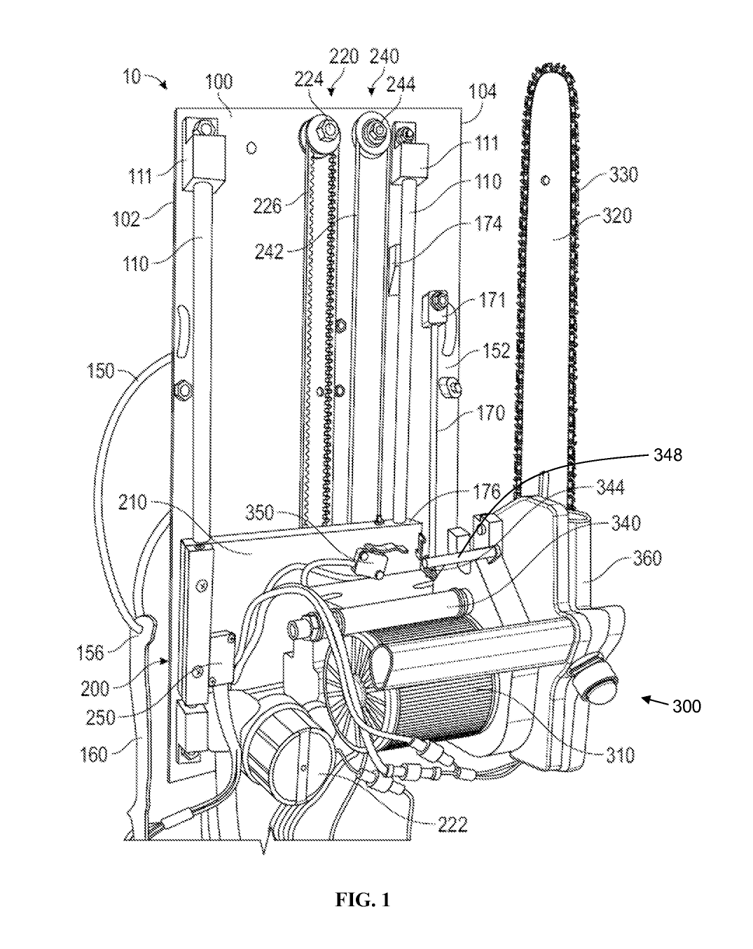

FIGS. 1-3 illustrate one embodiment of the apparatus of the present invention. The apparatus 10 may comprise a mounting platform 100, a carriage assembly 200 operably coupled to the carriage assembly, and a cutting assembly 300 operably coupled to the carriage assembly. The mounting platform 100 may comprise a generally planar platform; however, the platform may be a three-dimensional platform. In one embodiment, the mounting platform 100 is rectangular; however, the platform may be any polygonal shape. In other embodiment, the mounting platform 100 may have a different shape, such as square, trapezoidal, diamond, rhomboid, semicircular, other polygons, and/or the like.

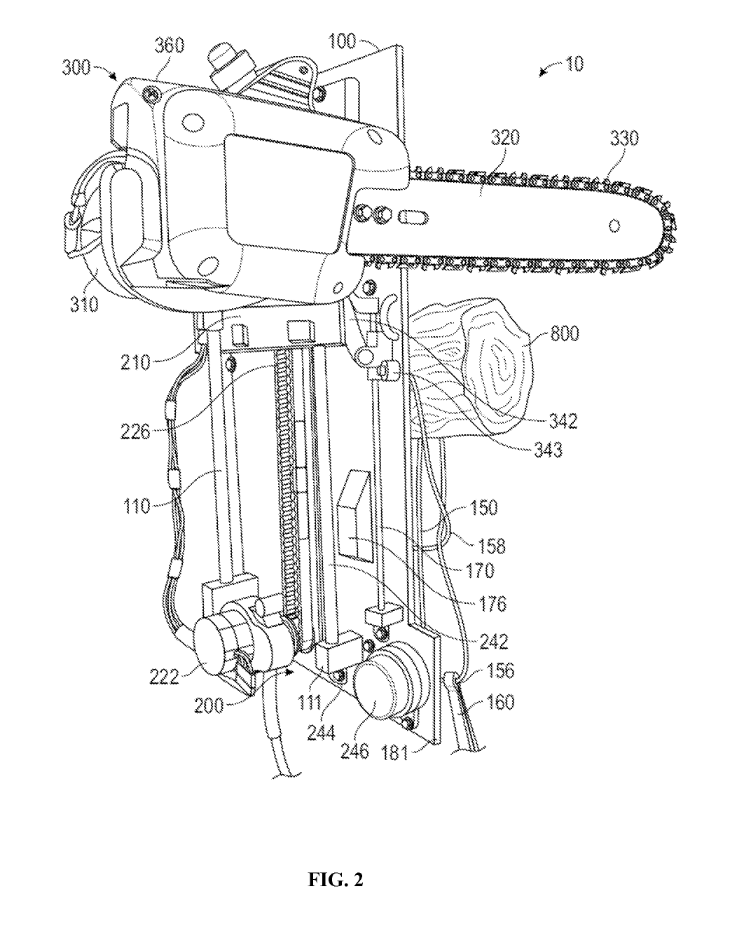

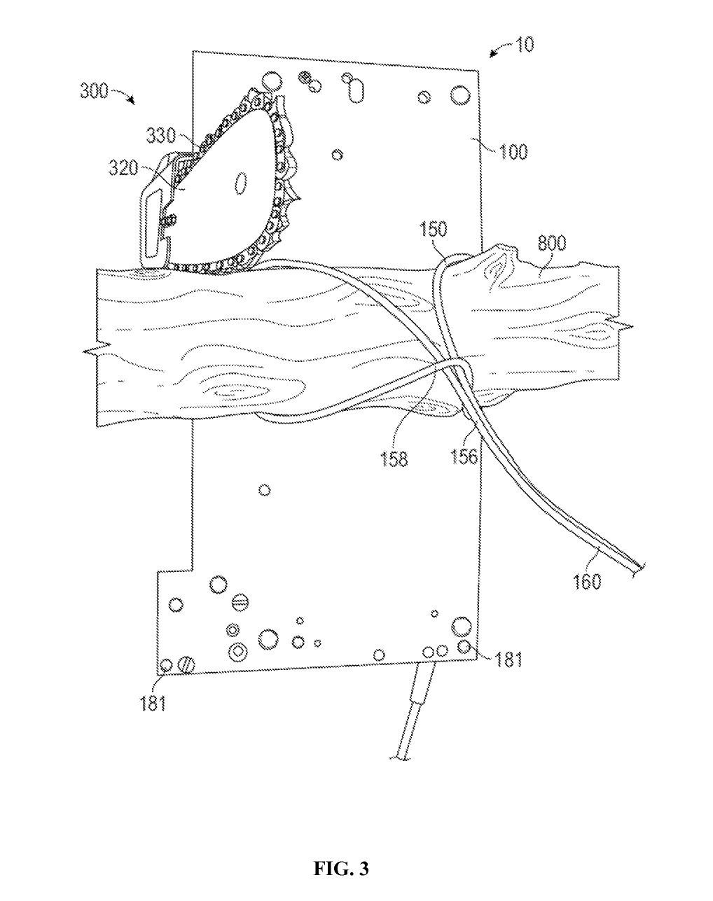

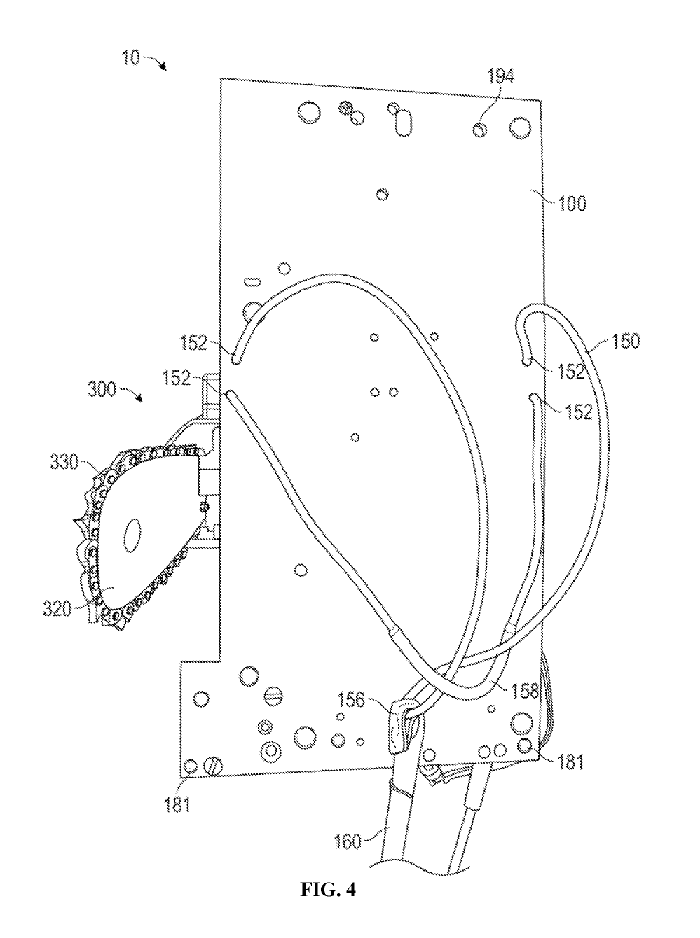

In some embodiments, the apparatus 10 further comprises a securing assembly 150 coupled to the mounting platform 100. In some embodiments, the apparatus 10 further comprises a lift member 160 coupled to the securing assembly 150. In some embodiments, the lift member 160 may comprise a rope, cable, steel cable, steel rope, and/or the like. The securing assembly 150 may secure the apparatus 10 to a tree limb, as illustrated in FIG. 2. In some embodiment, the securing assembly 150 may comprise a steel rope or cable. In some embodiments, the securing assembly 150 is permanently attached to the mounting platform 100. In some embodiments, the securing assembly 150 is attached to the mounting platform 100 such that the securing assembly 150 passes through holes 152 along opposite sides 102, 104 of the mounting platform 100, and ends of the securing assembly 150 are then joined to together with the lift member 160, as shown in FIGS. 3-4. In some embodiments, opposite ends of the securing assembly 150 are joined together with the lift rope 160 so as to form a “V” shape 156 where the ends of the securing assembly 150 are joined to the lift rope 160. In some embodiments, a thimble 158 may be coupled to the securing assembly 150 at an end opposite the “V” shape 156, in order to guide the lift rope 160 during lifting.

In use, the lift rope 160 is passed over the limb to be removed, and passed through the looped securing assembly 150. The lift rope 160 may then be pulled to lift the apparatus 10 to the tree limb to be removed. Once raised, the apparatus 10 is secured to the tree limb 800, as illustrated in FIGS. 2-4. The lift rope 160 can easily be held in place by the operator a distance from where the limb would fall or be lowered to the ground. In some embodiments, the operator may hold the lift rope 160 approximately 50 feet from where the limb would fall or be lowered to the ground. Alternatively, the lift rope 160 may be fixed to some affixation point (not shown), such as another tree, a screw type tie out stake, a post driven into the ground, a large weight, and/or the like, thereby securing the apparatus 10 against the tree limb 800. Preferably, the apparatus 10 is secured to the tree limb 800 such that the mounting platform 100 is perpendicular to the ground.

In some embodiments, one or more positioning lines 180 may be coupled to the mounting platform 100, so as to permit adjustment or alignment of the apparatus 10 once it is raised to the tree limb 800. In some embodiments, the one or more positioning lines 180 (not shown) may be coupled to one or more positioning line holes 181 in the mounting platform 100, as shown in FIGS. 3-4.

In some embodiments, the mounting platform 100 may further comprise at least one hole 190. The hole 190 may permit a supplemental securing assembly 192 to be engaged with the apparatus 10 and a tree limb 800 to provide additional support to the apparatus 10 while in use. An operator may make the determination whether the additional support is necessary in particular situations.

In some embodiments, the mounting platform 100 may further comprise at least one additional hole 194 on a side opposite the cutting assembly 300. The at least one additional hole 194 may be provided to perform a cut closer to the main tree trunk. The “V” shaped wire rope/strap guide 156 for the lift rope 160 may optionally not be used for this type of delimbing.

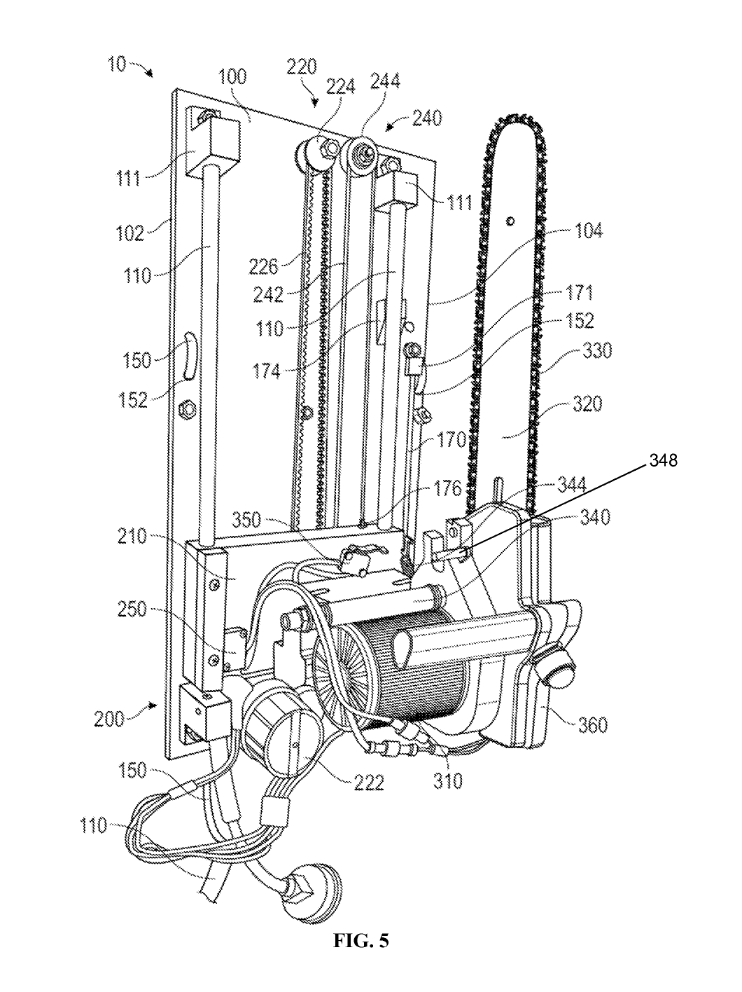

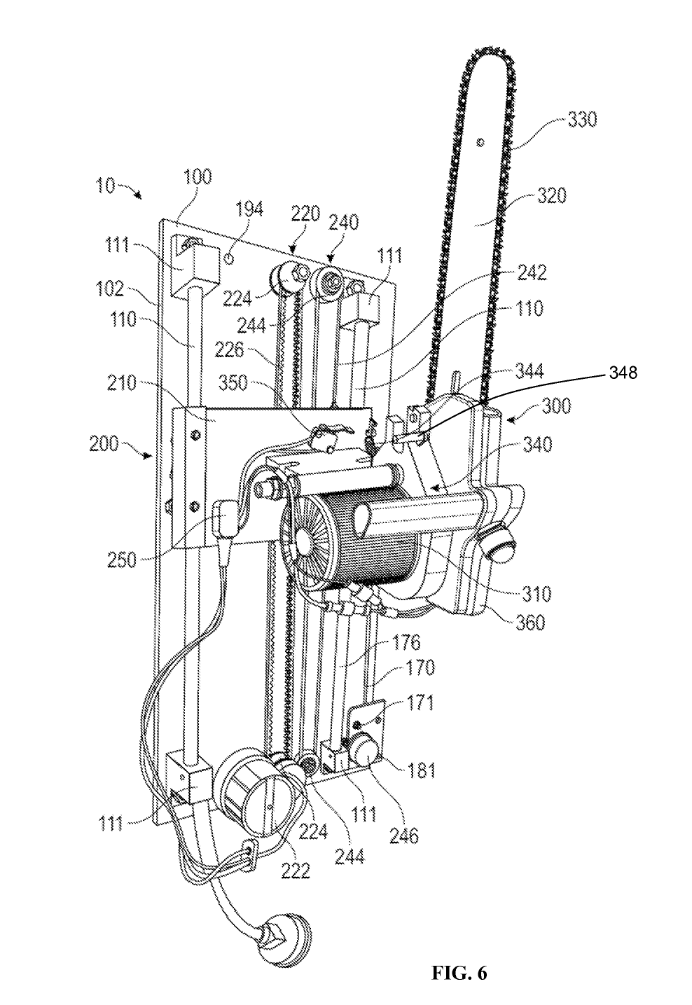

As shown in FIGS. 1-2, 5, 6, the carriage assembly 200 generally comprises a carriage platform 210 operably coupled to the mounting platform 100. In some embodiments, the mounting platform 100 further comprises one or more, preferably two, rails 110. Preferably, a first rail 110 is disposed generally along a first side 102 of the mounting platform 100, and a second rail 110 is disposed generally along a second side 104 of the mounting platform 100. The carriage platform 210 may comprise one or more, preferably two, linear bearings 212. At least one linear bearing 212 may be coupled to each rail 110, such that the carriage platform 210 is restricted to linear motion along the rails 110.

In one embodiment, the at least one rail 110 may comprise a rod. In one embodiment, the at least one rail 110 is mounted on the mounting platform by at least one formed rail support 111.

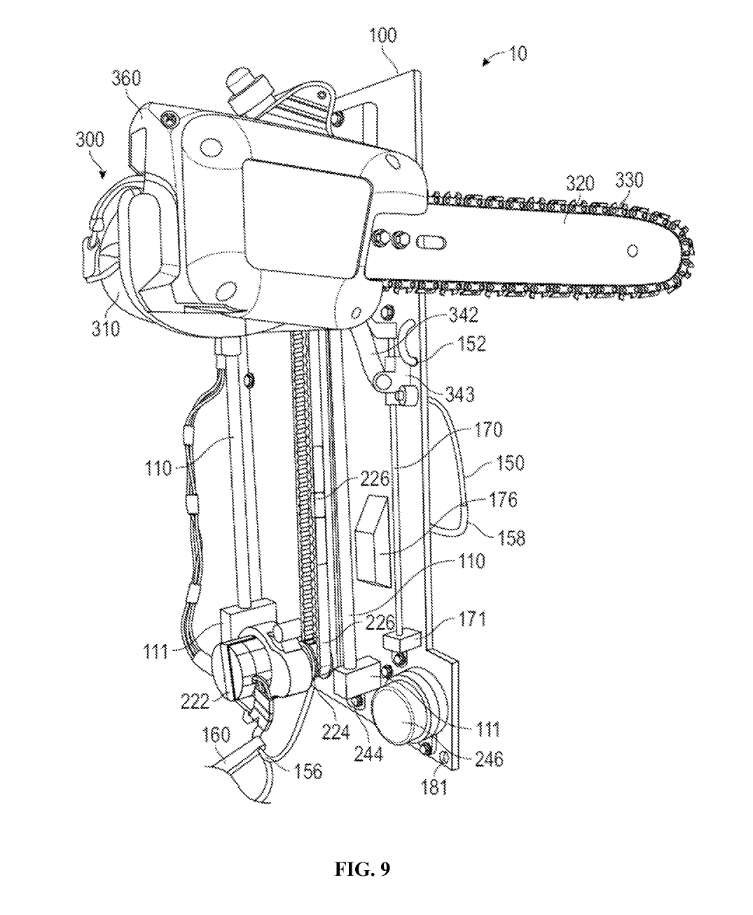

As shown in FIGS. 1-2, 5, 6, in one embodiment, the carriage assembly 200 further comprises a carriage drive assembly 220. In another embodiment, the carriage drive assembly 220 may be operably coupled to one or more of the at least one rail 110. The carriage drive assembly 220 may comprise a carriage motor 222, at least one carriage pulley 224, and a drive belt 226, as shown in FIGS. 1, 5, 6, and 9. The motor 222 may be mounted on the mounting platform 100. The at least one pulley 224 may be mounted on the mounting platform 100. The drive belt 226 may be operably coupled to the carriage platform 210, the carriage motor 222, and the at least one carriage pulley 224, such that the motor 222 drives the drive belt 226 to translate the carriage platform 210 along the rails 110. In other embodiments, the carriage drive assembly 220 may comprise any means as known in the art for translating the carriage platform 210, including but not limited to a chain drive assembly, a ball screw assembly, other linear actuators, other belt and pulley assemblies, and/or the like.

As shown in FIGS. 1, 5, 6 The carriage assembly 200 may further comprise a linear tension spring cable assembly 240. The spring cable assembly 240 may comprise a cable 242, at least one pulley 244, and a counter balance coil spring 246. The spring cable assembly 240 may be operably coupled to the carriage platform and the mounting platform 100, such that the cable 242 around the at least one pulley 244 (mounted to the mounting platform 100) and to the counter balance coil spring 246. In some embodiments, a second pulley 244 is mounted to the mounting platform 100, as shown in FIG. 2.

As shown in FIGS. 1, 5, and 6, in one embodiment, the carriage assembly 200 further comprises at least one switch member 250. The switch member 250 may be configured such that when the carriage platform 210 reaches the top of the rails 110, the switch member 250 is actuated and reverses the direction of the carriage drive assembly 220, such that that carriage platform 210 returns to the rest position at the bottom of the rails 110. In one embodiment, the switch member 250 may comprise a roller dual pole switch assembly. In one embodiment, the switch member 250 may comprise a roller switch 112. In one embodiment, the switch member 250 may interact with at least one detent 114 on at least one of the rails 110 to reverse the direction of the carriage drive assembly 220 as the carriage platform 210 reaches the top of the rails 110. In another embodiment, the at least one switch member 250 is adjustable, such as by an adjustable screw, to alter the travel path or length of the carriage platform 210.

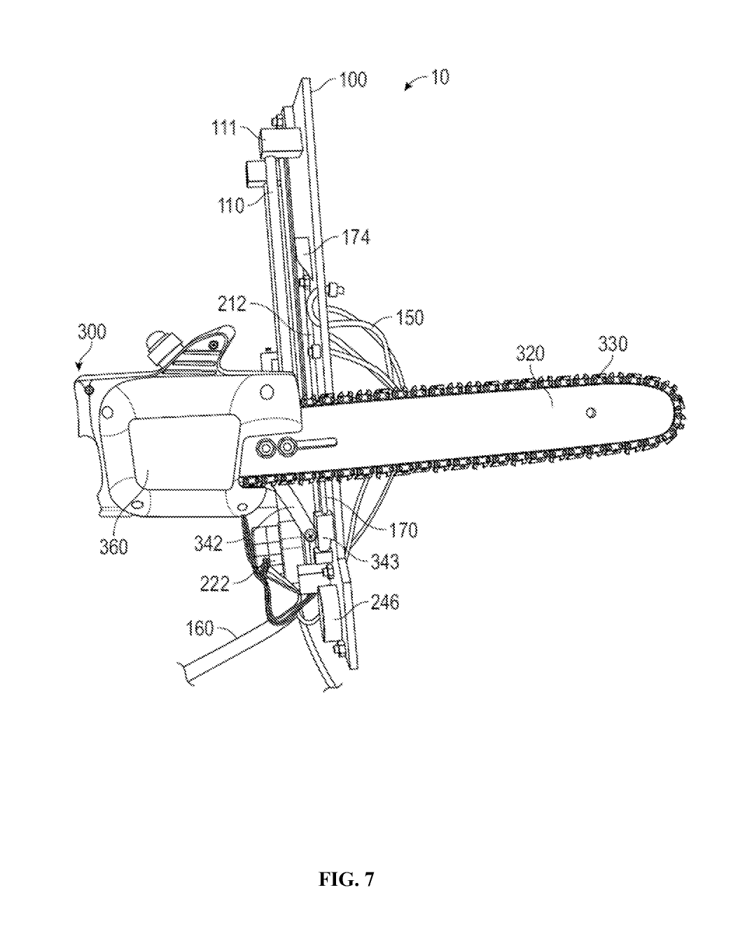

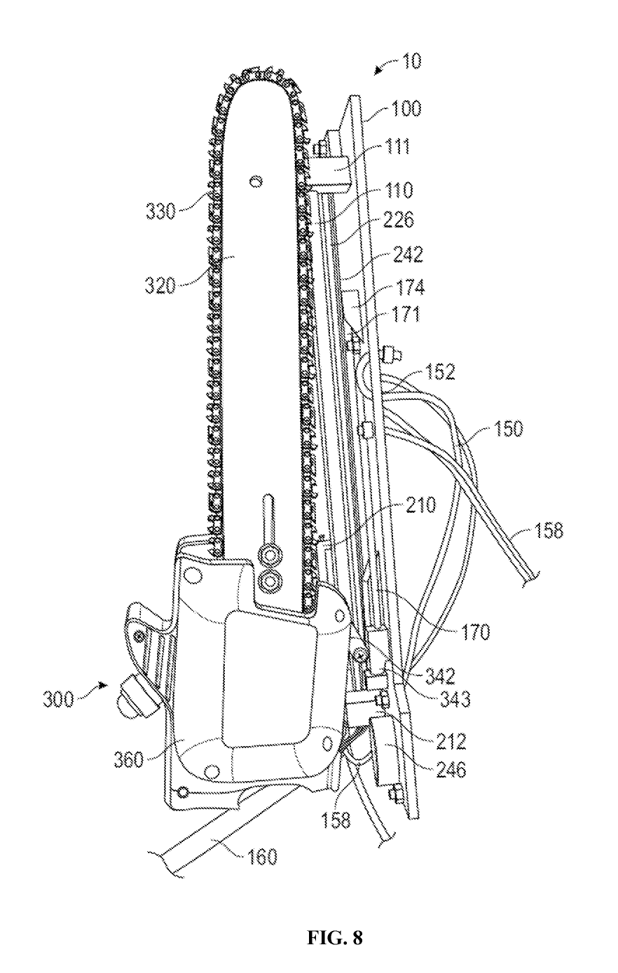

As shown in FIGS. 1-9, the cutting assembly 300 generally comprises a bar and chain mechanical saw assembly. In one embodiment, the cutting assembly 300 generally comprises a chain saw. The cutting assembly may comprise a motor 310, a bar 320, and a chain 330. The cutting assembly 300 is mounted on the carriage platform 210. In some embodiments, the cutting assembly 300 further comprises a rotation assembly 340, as shown in FIGS. 1, 5, and 6. The rotation assembly 340 may comprise a linkage arm 342 and a mechanical spring lock 344, as shown in FIGS. 2, 5, 6-9. The linkage arm 342 is operably coupled to a linkage rail 170, the linkage rail 170 mounted on the mounting platform 100. In some embodiments, the linkage arm 342 is coupled to the linkage rail 170 by a formed bearing 343, such as but not limited to a linear bearing. In some embodiments, the linkage rail 170 is mounted to the mounting platform 100 by at least one formed rail support 171. The linkage rail 170 may have a length less than the carriage rails 110, to permit the linkage arm 342 to initiate pivoting of the cutting assembly 300 between a rest position and an operating position, and vice versa. The linkage arm 342 and linkage rail 170 are configured such that as the linkage arm 342 reaches the top end of the rail 170, the cutting assembly 300 is pivoted by the linkage arm 342 from a vertical to a horizontal position. The mechanical spring lock 344 may be configured to lock the cutting assembly 300 in the horizontal position operably coupled to an arm assembly 348 that is mounted to the bar-chain housing assembly. In one embodiment, a wedge 174 may be mounted on the mounting platform 100, configured such that the wedge 174 actuates the mechanical spring lock 344 as the carriage platform 210 reaches the top of the rails 110 and the cutting assembly 300 is pivoting into the operating position by the linkage arm 342. In one embodiment, a wedge 176 may be mounted on the mounting platform 100, configured such that the wedge 176 releases the mechanical spring lock 344 as the carriage platform 210 returns to the rest position. In one embodiment, the cutting assembly 300 further comprises a switch 350. In one embodiment, the switch 350 is configured such that the cutting assembly 300 is powered on after being locked in the horizontal position by the mechanical spring lock 344, and powered off after the mechanical spring lock 344 is released and the cutting assembly 300 returns to the vertical rest position. In one embodiment, the switch 350 is actuated by an arm mounted to the cutting assembly 300. In one embodiment, the switch 350 is a momentary switch.

In some embodiments, a cover member 360 may enclose at least a portion of the cutting assembly 300.

In some embodiments, the carriage drive assembly 220 is gas powered. In some embodiments, the carriage drive assembly 220 is battery powered. In some embodiments, the carriage drive assembly 220 may be electrically coupled to an AC or DC power source (not shown), such as but not limited to an electrical outlet or an electrical generator, for example by a power cord.

In some embodiments, the cutting assembly 300 is gas powered. In some embodiments, the cutting assembly 300 is battery powered. In some embodiments, the cutting assembly 300 may be electrically coupled to a power source (not shown), such as an electrical outlet or an electrical generator, for example by a power cord.

A controller 400 may be operably coupled to the apparatus 10. In one embodiment, the controller 400 is wired to the apparatus 10. In one embodiment, the controller 400 is wirelessly coupled to the apparatus 10. In one embodiment, the controller 400 comprises a switch lockout and a trigger switch.

A method of removing tree limbs with the apparatus may comprise the steps of lifting the apparatus to a tree limb with the lifting member, securing the apparatus to the tree limb with the securing assembly; and operating the apparatus. In some embodiments, the method may further comprise translating the carriage assembly from a first rest position to a second operating position. In some embodiments, the method may further comprise pivoting the cutting assembly from a rest position to an operating position. In some embodiments, the method may further comprise activating the cutting assembly. In some embodiments, the method may further comprise translating the carriage assembly from the second operating position back to the first rest position. In some embodiments, the method may further comprise pivoting the cutting assembly from the operating position to the rest position. In some embodiments, the method may further comprise deactivating the cutting assembly. In some embodiments, the method may further comprise releasing the securing assembly and removing the apparatus from the tree limb.

In some embodiments, activating the cutting assembly may further comprise locking the cutting assembly in the operating position with a mechanical spring lock. In some embodiments, deactivating the cutting assembly may further comprise releasing the mechanical spring lock.

Additional embodiments of the present invention are described below.

A main mounting platform with a lower section, a middle section and a top section. A main mounting platform consisting of a front side which secures the mechanical cutting/motion assemblies. A main mounting platform consisting of a back side which secures steel wire cables for transporting the delimber to the branch. A main mounting platform consisting of a back side which secures steel wire cables for securing the cutting device to the lower section of the branch to be cut. A motor platform consisting of a flat surface with a dual linear bearing. A motor platform to transport the cutting mechanism from the lower/front section to the top/front section. A dual linear bearing platform designed to support the motor, bar and chain assembly. A parallel rod/bearing system is anchored to the front side of the main platform on opposing sides and secured on the top and bottom of the main platform to guide the linear bearing platform.

In one embodiment, a formed block is mounted to the main platform used to anchor and support the ends of the parallel rod/bearing system. A fixed bearing motor support is secured to the motor linear bearing platform to support the motor and allows the motor/bar/chain to pivot in a 90 degree motion on a central axis. A mounting carriage is affixed to the cutting motor and supports a rod bearing that extends through the fixed bearing primary motor support to allow the 90 degree motion on a central axis. A bar/chain motor that supports and powers a bar/chain assembly for cutting. A chain guide bar extending out from the main motor. An endless cutting chain is attached to a guide bar. A steel wire rope assembly permanently attached on opposing sides to the front/top of the platform. A steel wire rope assembly permanently attached on the opposing sides of the back side middle section of the platform. A thimble is attached to the wire rope located at the backside middle section. A reversible gearmotor and timing belt/chain system will transport the motor and bar/chain from the lower to the top section of the main platform and into a cutting limb position and reverse.

In one embodiment, standoffs are secured to the main platform to support the reversible gearmotor. An endless timing belt that is anchored to the underside of the linear bearing motor platform to transport the motor/bar/chain assembly for bottom to top and reverse. A rigid 90 degree angel support is anchored to the underside of the linear bearing motor platform to attach the endless timing belt. A timing-belt pulley is mounted to the front top of the main platform is used to support the timing chain/belt to complete the endless chain/belt travel cycle. A linear counter balance coil spring assembly with cable is mounted to the lower right of the front main platform. A pulley is located at the top right section of the main platform to guide the counter balance wire cable. A linear counter balance coil spring with wire rope is guided by a pulley at the top of the main platform and secured to the linear bearing primary motor platform. A momentary switch is attached with an enclosed actuator housing on the left side of the linear bearing platform. An adjustable screw is inserted in the momentary actuator switch actuator for travel adjustment. A single rail bearing assembly is attached to the front right middle section of the platform.

In one embodiment, a formed mounting block is secured to the main platform at both ends to support the single rail bearing assembly. A linkage arm is attached to the single rail bearing. A linkage arm extends to the motor housing to rotate the bar/chain to the horizontal cutting position at the top and perpendicular to the main mounting platform. A dual pole on/off momentary switch is mounted to the right side of the linear bearing platform. A rod is affixed to motor carriage to activate the momentary motor/bar/chain motor switch. A linkage arm is affixed to the side of the linear bearing platform and pivots to act as a positive mechanical lock for the motor/bar/chain at 90 degree rotation to form the cutting position. A linkage arm is affixed to the side of the linear bearing platform and pivots to act as a positive mechanical lock when the motor/bar/chain travels to the bottom of the main platform in a park position and is parallel to the main platform. A spring is attached from the linear bearing platform to the pivoting linkage arm to form a mechanical lock at 90 degree rotation. A wedge shaped platform mounted at the top of the front side of the main platform will activate the mechanical spring lock linkage arm assembly. A wedge shaped platform mounted at the bottom of the front side of the platform will deactivate the mechanical spring lock linkage arm assembly.

In one embodiment, a cover assembly enclosing the motor, bar/chain, electric and mechanical components attached to the front of the main platform. A switch lockout and trigger switch is used to apply power to the unit to maximize operator safety. Power is applied to the motor/bar/chain unit when the linear bearing platform travels to the top position and then rotates to the 90 degree locked horizontal cutting position. The bar/chain motor switch is activated after reaching the top platform position and after the motor bar/chain has rotated 90 degrees from vertical to horizontal. The main motor assembly performs the same operation whether the power source is gas, AC, DC or battery powered motor type. A rope/cable will lift the unit to the cutting area of the branch to be delimbed. A lift rope will be threaded through the ‘V’ shaped cable attached to the backside middle rear of the platform to secure and stabilize the trimmer to the branch to be cut. A lift rope/cable will be attached to the steel rope 4 affixed to the platform. A steel rope forms a “V” shape where attached lifting rope. A thimble is secured to the center of the “V' shaped cable assembly to guide the lift rope cable. A motor and bar/chain assembly is parallel to the main platform at the lower top section of the main platform and in a park position when not in operation. A motor/bar/chain rotates 90 degrees at the top of the platform and is perpendicular to the platform when in the cutting position.

In one embodiment, a main mounting platform is perpendicular to the ground during the cutting operation. A motor/bar/chain is horizontal to the ground during the cutting operation. A timing belt multiple pulley system will transport the motor and bar/chain from the lower section to the top section. A gear motor will be anchored by standoffs at the lower left front section of the main platform. A timing gear is secured to the gear motor output shaft to drive the timing belt. A gear motor output drive shaft passes through the main platform to act as guide bearing guide. A gear motor will drive an endless timing drive belt to an anchored timing pulley at the top/front. An endless timing drive belt will extend from the lower to top sections. A rigid 90 degree angel support anchors the endless timing belt to the underside center of the linear bearing motor platform and is perpendicular to platform. A mechanical spring lock assembly will lock the motor bar/chain at the 90 degree to main platform position for the cutting operation. A linear bearing platform supports a roller dual pole switch assembly switches/reverses power to the gearmotor allowing the carriage to travel from the bottom front side lower park position to top front side precut position and reverses the motion.

In one embodiment, a linkage arm extends to the motor housing to rotate the bar/chain to the horizontal cutting position at the top and to a park position at the lower end of the main front side platform. A linkage arm/bearing travel is limited as it moves to the top and bottom and reverse on the main platform and is attached to the motor/bar/chain enclosure which causes the rotation of the motor/bar/chain assembly. A mounting bracket is affixed to the underside of the linear bearing platform to the timing belt to lift the carriage to the top position and reverse direction to the lower section. A bar/chain motor ‘ON’ switch is activated after reaching the top platform position and the motor bar/chain has rotated 90 degrees from vertical to horizontal. A rotation bar/chain arm will lock and secure the transport carriage to the platform when in the lower park position. A linear tension spring cable assembly is mounted to the lower front section to offset the weight of the linear bearing platform, primary motor, bar and chain. A linear tension spring cable pulley is attached to the top front of the main platform and routed to the linear bearing platform. A gearmotor provides the power to control the up/down motion for the linear bearing travel. A normally open roller switch assembly switches/reverses power to the gearmotor allowing the carriage to travel from the bottom to top position and reverse. A normally open roller reverse direction switch is mounted inside a protective housing on the left side of the linear bearing platform assembly.

In one embodiment, a roller switch mounted on the linear bearing platform is activated by a rod with detents that travels inside an enclosure to reverse the bottom to top and top to bottom linear bearing platform direction. A rod with detents senses the up and down limits to reverse the gearmotor direction and therefor linear bearing platform direction. A normally open contact roller switch is mounted to the right side linear bearing platform assembly and activated by a linear rod secured to the motor support motor carriage which supports the bar/chain. An arm is mounted to the rotating bar/chain assembly to activate the momentary bar/chain motor switch.

The bar/chain motor switch is activated after reaching the top platform position and the motor bar/chain has rotated 90 degrees from vertical to horizontal. Power to the motor/bar/chain unit is terminated when the bar/chain carriage travels to the lower section of the platform and the motor/bar/chain begins its vertical rotation and parallel to the main platform to the lower park position. A hole in the upper and left side of the main platform is provided so that an additional clamp/rope can support the complete unit when in use if the operator sees a need. A hole in the upper and left side of the main platform is provided to perform a cut closer to the main tree trunk. The “V” shaped wire rope/strap guide for the lift rope/cable is not used for this type of delimbing. A hole at the bottom on left and right sides of the main platform is provided so additional cable/rope guides can be attached to assist the operator in positioning the unit on the limb to be cut.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. An apparatus for removing tree limbs comprising:
a. A mounting platform;
b. At least one lifting member for lifting the mounting platform to a tree limb;
c. At least one securing assembly for securing the mounting platform to the tree limb;
d. A carriage assembly operably coupled to the mounting platform;
e. A cutting assembly operably coupled to the carriage assembly; and
f. A power source.

2. The apparatus of claim 1, wherein the lifting member comprises a rope, a cable, and/or the like.

3. The apparatus of claim 1, wherein the securing assembly comprises a steel rope affixed to the mounting platform.

4. The apparatus of claim 1, wherein the lifting member is coupled to the securing assembly.

5. The apparatus of claim 1, wherein the cutting assembly comprises a mechanical saw assembly.

6. The apparatus of claim 5, wherein the cutting assembly comprises a cutting motor, a bar, and a cutting chain.

7. The apparatus of claim 1, wherein the mounting platform is generally planar.

8. The apparatus of claim 1, wherein the carriage assembly comprises at least one rail, a carriage platform, and a carriage drive assembly.

9. The apparatus of claim 8, wherein the carriage drive assembly is mounted on the mounting platform.

10. The apparatus of claim 8, wherein the carriage assembly further comprises at least one switch member, the switch operable to reverse the direction of the carriage drive assembly.

11. The apparatus of claim 1, further comprising at least one positioning member operably coupled to the mounting platform.

12. The apparatus of claim 1, further comprising at least one supplemental securing member.

13. The apparatus of claim 1, further comprising at least one rotation assembly operably coupled to the cutting assembly, wherein the rotation assembly is configured to pivot the cutting assembly from a vertical rest position to a horizontal operating position.

14. The apparatus of claim 13, wherein the rotation assembly comprises a linkage rail mounted to the mounting platform, a linkage arm between the linkage rail and the cutting assembly, and a mechanical spring lock.

15. The apparatus of claim 14, further comprising at least one wedge member disposed on the mounting platform, wherein the at least one wedge member is configured to actuate the mechanical spring lock.

16. The apparatus of claim 1, further comprising a controller operably coupled to the apparatus, wherein the controller comprises a trigger switch and a switch lockout.

17. The apparatus of claim 1, further comprising a counterbalance assembly.

18. The apparatus of claim 17, wherein the counterbalance assembly comprises a linear tension spring cable assembly.

19. A method of removing tree limbs with an apparatus comprising a mounting platform, at least one lifting member for lifting the mounting platform to a tree limb, at least one securing assembly for securing the mounting platform to the tree limb, a carriage assembly operably coupled to the mounting platform, a cutting assembly operably coupled to the carriage assembly, and a power source, comprising the steps:
a. Lifting the apparatus to a tree limb with the lifting member;
b. Securing the apparatus to the tree limb with the securing assembly; and
c. Operating the apparatus.

20. The method of claim 19, wherein the step of operating the apparatus further comprises the steps of:
a. Translating the carriage assembly from a first rest position to a second operating position;
b. Pivoting the cutting assembly from a rest position to an operating position;
c. Activating the cutting assembly;
d. Translating the carriage assembly from the second operating position back to the first rest position;
e. Pivoting the cutting assembly from the operating position to the rest position; and
f. Deactivating the cutting assembly.
